(19) United States
(12) Patent Application Publication
(10) Pub. No.: US 2023/0390135 A1
(43) Pub. Date: Dec. 7, 2023

(54) PORTABLE WASTE RECEPTACLE DEVICE AND PORTABLE APPARATUS

(71) Applicant: Helen Jane Stewart-Brooks El, Merrillville, IN (US)

(72) Inventor: Helen Jane Stewart-Brooks El, Merrillville, IN (US)

(21) Appl. No.: 18/144,168

(22) Filed: May 5, 2023

Related U.S. Application Data
(60) Provisional application No. 63/338,505, filed on May 5, 2022.

(51) Int. Cl. A61G 9/00

(52) U.S. Cl. CPC A61G 9/003

(57) ABSTRACT

The present invention is a portable waste receptacle device or container, and a portable apparatus having the portable device or container and a portable stand. Further, each of the portable waste receptacle device or container or apparatus may also include a lid. As a non-limiting example, the portable waste receptacle device or container includes a base, a plurality of sidewalls, and an open upper end defining an internal volume. The plurality of sidewalls extends upwardly from the base. Preferably, a pair of opposing sidewalls of the plurality of sidewalls include curved inlets. As a non-limiting example, the portable stand includes at least one leg support, a vertical support, and at least one securement.

### CROSS-REFERENCE TO RELATED APPLICATIONS

The present application claims the priority benefit of U.S. Provisional Patent Application Ser. No. 63/338,505, filed on May 5, 2020 and titled “Female Urine Receptacle,” which is incorporated herein by reference in its entirety.

### BACKGROUND OF THE INVENTION

### Field of the Invention

The present invention relates generally to portable waste receptacles, devices, and apparatuses. More particularly, the present invention is a portable waste receptacle device, and a portable apparatus having the receptacle device and a portable stand.

### Description of the Related Art

Portable waste receptacles, devices, and apparatuses are known in the art.

Whether an individual has a physical disability, or they are immobilized due to an injury or illness, it may be difficult for them to get out of their bed. Typically, these individuals require some assistance from a caretaker to get in and out of their bed. A common instance where the individual needs to get out of their bed is to use the restroom. Once the individual is helped from the bed, they might also need assistance being transported to the restroom or even using the facilities. When unable to use the restroom, accidents may occur, resulting in a heavily unsanitary mess and significant embarrassment for the individual. Typically, bed pans and commodes are located near the bed to reduce the need to walk to a restroom. However, some of these bedside devices are not conducive to both men and women having an easy experience using the restrooms.

Additionally, when traveling long distances, locating a public restroom while traveling can be difficult. Moreover, individuals may lack access to a restroom. Furthermore, the bathroom that may be accessible can be unsanitary and messy. In certain situations, this can make it difficult for females to have the convenience of a bathroom when driving long distances. In order to address these concerns, the present invention provides the user with a portable urine receptacle that can be conveniently used anywhere while on-the-go.

The present invention overcomes one or more of the shortcomings of portable waste receptacles, devices, and apparatuses. The Applicant is unaware of inventions or patent documents, taken either singly or in combination, which are seen to describe the present invention as claimed.

One advantage of the portable waste receptacle device and the portable apparatus is that it provides users with a convenient and portable waste receptacle device during travel or where waste receptacle devices are not easily accessed or located.

Another advantage of the portable waste receptacle device and the portable apparatus is that it provides users with a waste receptacle device that is clean and sanitary for use in comparison to those waste receptacle devices provided in public restrooms or locations.

A further advantage of the portable waste receptacle device and the portable apparatus is that it can be dimensioned and configured for users of different heights and/or sizes.

### SUMMARY OF THE INVENTION

The present invention is a portable waste receptacle device or container, and a portable apparatus having the portable waste receptacle device or container and a portable stand. Further, each of the portable waste receptacle device or container or apparatus may also comprise a lid, such as, but not limited to, a detachable lid or a hinged lid.

As a non-limiting example, the portable waste receptacle device or container comprises a planar base, a plurality of sidewalls, and an open upper end defining an internal volume. The planar base includes a plurality of edges. The plurality of sidewalls extends upwardly from the plurality of edges of the planar base at an outward angle. A pair of opposing sidewalls of the plurality of sidewalls include curved inlets.

As a non-limiting example, the stand includes a plurality of leg supports, a vertical support, and a plurality of securements.

### BRIEF DESCRIPTION OF THE DRAWINGS

FIG. 1 is a perspective view of an embodiment of a portable waste receptacle device according to the present invention;

FIG. 2 is an environmental, perspective view of the portable waste receptacle device of FIG. 1;

FIG. 3 is an exploded view of an embodiment of a portable apparatus having a portable waste receptacle device and a portable stand according to the present invention;

FIG. 4 is a side view of the portable apparatus of FIG. 3;

FIG. 5 is an environmental, perspective, end view of the portable waste receptacle device of FIG. 1; and

FIG. 6 is an environmental, perspective, end view of the portable waste receptacle device of FIG. 1.

It should be understood that the above-attached figures are not intended to limit the scope of the present invention in any way.

### DETAILED DESCRIPTION OF THE EMBODIMENTS OF THE PRESENT INVENTION

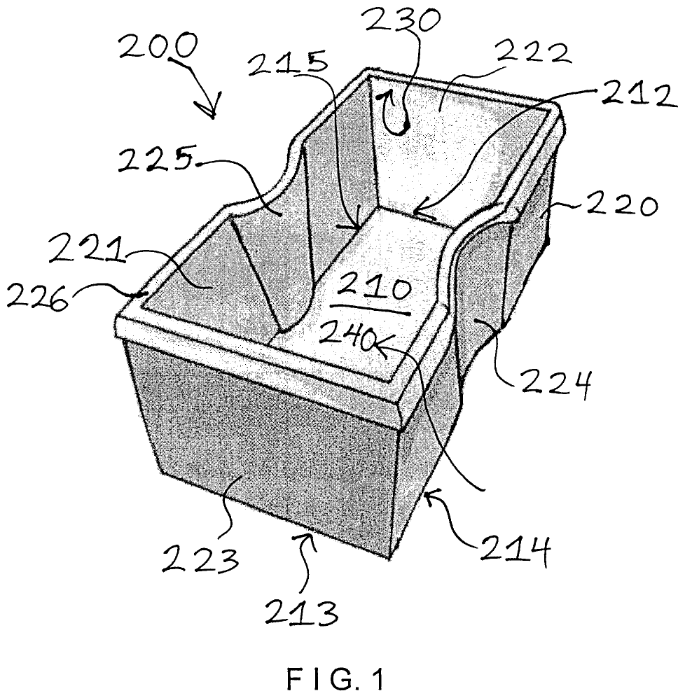

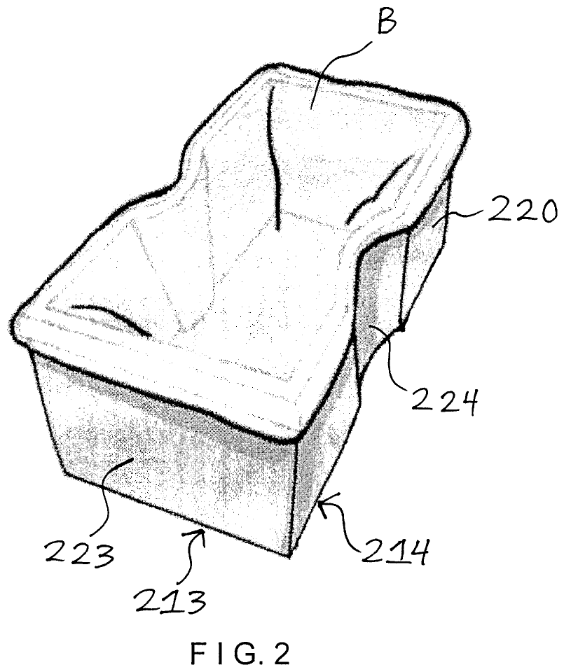

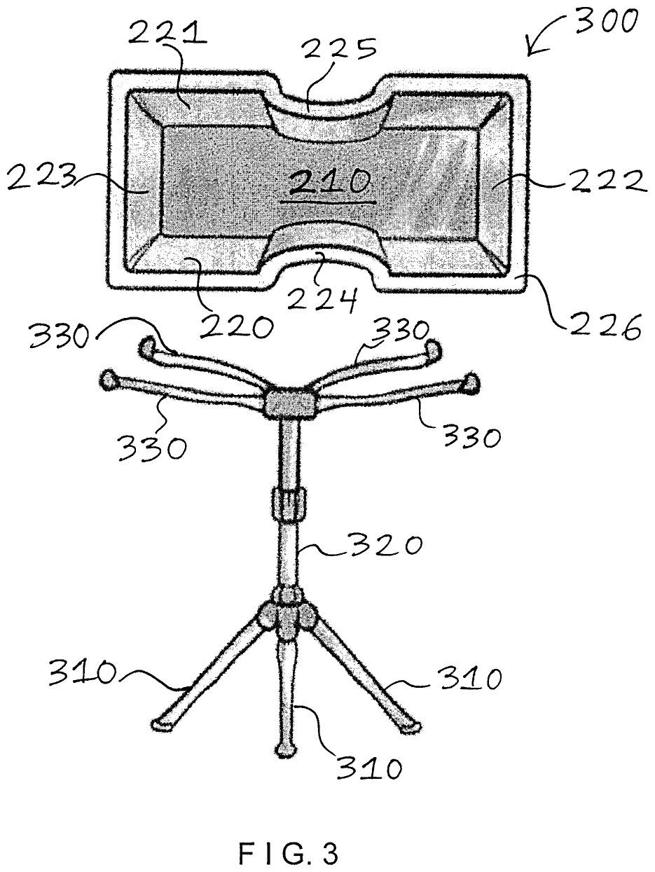

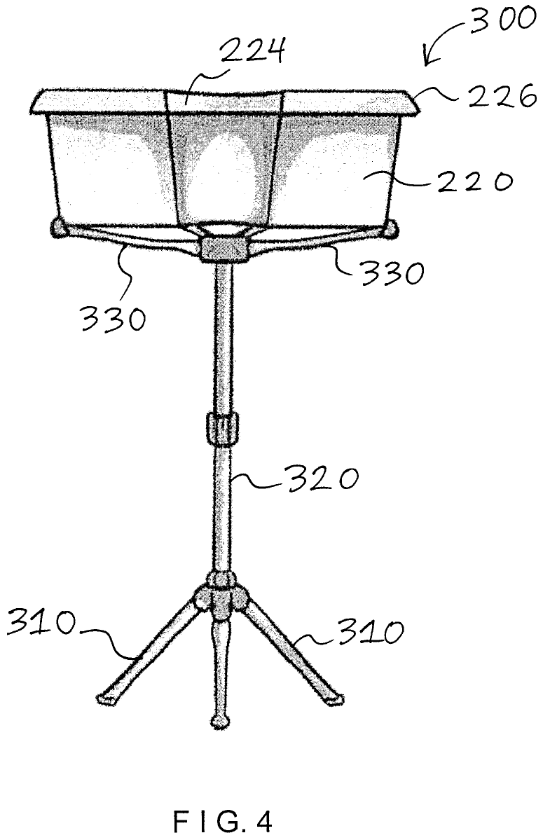

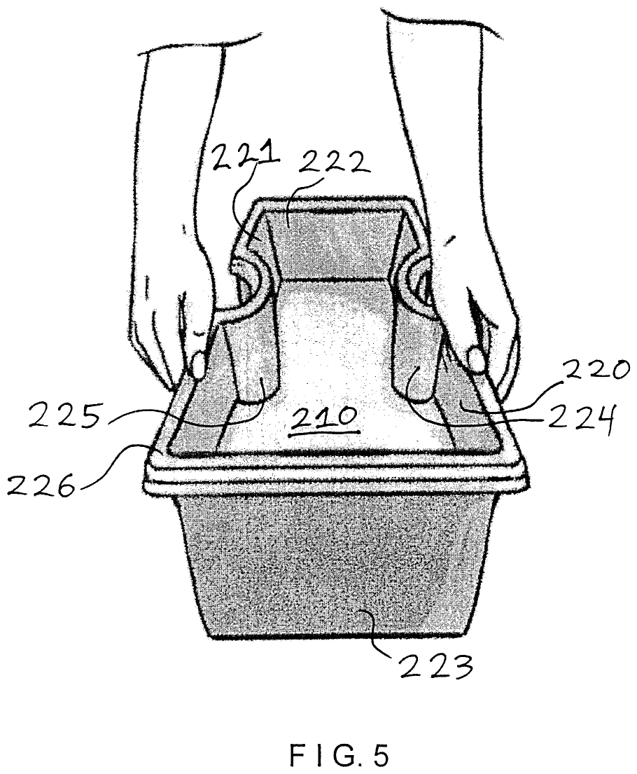

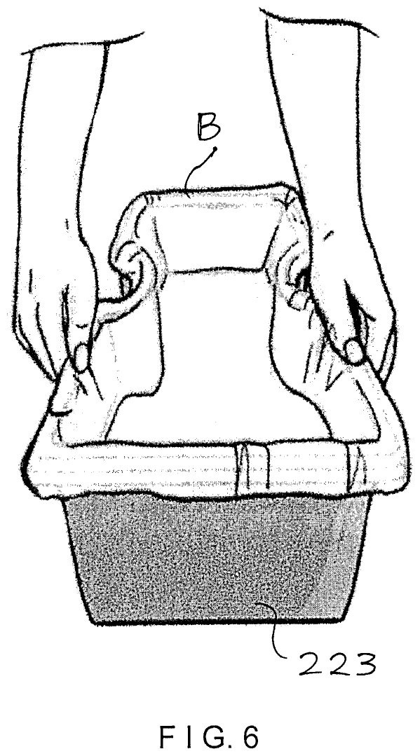

Referring to FIGS. 1-6, the present invention is a portable waste receptacle device or container 200, and a portable apparatus 100 having the portable waste receptacle device or container 200 and a portable stand 300. Further, each of the portable waste receptacle device or container 200 or apparatus 100 may also comprise a lid, such as, but not limited to, a detachable lid or a hinged lid.

As a non-limiting example, the portable waste receptacle device or container 200 comprises a base (preferably a planar base), a plurality of sidewalls, and an open upper end defining an internal volume. The planar base includes a plurality of edges. The plurality of sidewalls extends upwardly from the plurality of edges of the planar base at an outward angle. A pair of opposing sidewalls of the plurality of sidewalls include curved inlets. The plurality of sidewalls further comprises a lip. The lip is positioned around the exterior of the container. The lip around the curved inlets provides a handle thereon to assist in transporting the container, at the edge of the device. Moreover, a bag may be placed within the internal volume. The edge of the bag may be secured to the container via the lip to prevent the bag from moving when the device is in use. In one embodiment, a removable/detachable lid or hinged lid may be secured to the open upper end of the container. In said embodiment, the removable/detachable lid or hinged lid may be attached or completely taken off of the container.

As a non-limiting example, the portable stand 300 includes at least one (preferably a plurality of) leg support(s), a vertical support, and at least one (preferably a plurality of) securement(s). The vertical support is sandwiched between the plurality of leg supports and the plurality of securements. The vertical support is telescopically adjustable. The plurality of leg supports is adjustable via individual hinges which secures each leg support of the plurality of leg supports to the vertical support. The plurality of securements is designed to grasp the container and secure it to the stand.

In use, the container may be secured between the user's legs whereby each leg is positioned in the curved inlet on the plurality of sidewalls. In use, the user can position themselves over the device while grasping the edge of the device for support, allowing a female user to more easily urinate or defecate when in a standing position, crouched position, or sitting position. When a bag is placed within the internal volume, the bag may be removed following use. Additionally, the container may be placed on the stand if the individual is unable to hold the container between their legs or they are unable to be in a squatting position when the container is positioned on the ground surface. The stand may be raised or lowered and preferably secured or locked into a preferred use position.

The portable stand may be collapsed into a smaller or retracted form or version for stowage and/or transport. Preferably, the portable stand may include (or extended or retracted) multiple height positions for use/operation for users of different heights.

Each of the portable waste receptacle device or container 200, portable stand 300, and lid may be made or manufactured of different dimensions and/or heights.

Each of the portable waste receptacle device or container 200, portable stand 300, and lid may be made or manufactured of plastic, wood, metal material, aluminum, glass, ceramic, and any combination thereof.

It is to be understood that the present invention is not limited to the embodiments described above or as shown in the attached figures, but encompasses any and all embodiments within the spirit of the invention.

1. A portable waste receptacle device or container comprising:
a base;
a plurality of sidewalls,
wherein said plurality of sidewalls extends upwardly from said base,
wherein a pair of opposing sidewalls of said plurality of sidewalls comprise curved inlets; and
an upper end defining an internal volume.

2. The portable waste receptacle device or container according to claim 1, wherein said base is planar.

3. The portable waste receptacle device or container according to claim 1, wherein said upper end is open.

4. The portable waste receptacle device or container according to claim 1, further comprising a lid dimensioned and configured for closing said upper end when desired.

5. A portable waste receptacle apparatus comprising:
a waste receptacle device or container comprising a base, a plurality of sidewalls, and an upper end defining an internal volume,
wherein said plurality of sidewalls extends upwardly from said base, and
wherein a pair of opposing sidewalls of said plurality of sidewalls comprise curved inlets; and
a portable stand comprising at least one leg support, a vertical support, and at least one securement.

6. The apparatus according to claim 5, wherein said upper end is open.

7. The apparatus according to claim 5, further comprising a lid dimensioned and configured for closing said upper end when desired.
